(19) United States
(12) Patent Application Publication
(10) Pub. No.: US 2017/0352267 A1
(43) Pub. Date: Dec. 7, 2017

(54) SYSTEMS FOR PROVIDING PROACTIVE INFOTAINMENT AT AUTONOMOUS-DRIVING VEHICLES

(71) Applicant: GM Global Technology Operations LLC, Detroit, MI (US)

(72) Inventors: Eli Tzirkel-Hancock, RA'ANANA (IL); Claudia V. Goldman-Shenhar, MEVASSERET ZION (IL)

(21) Appl. No.: 15/608,837

(22) Filed: May 30, 2017

Related U.S. Application Data
(60) Provisional application No. 62/344,696, filed on Jun. 2, 2016.

(51) Int. Cl. G08G 1/0962; H04L 29/08; G09B 5/02; G05D 1/00

(52) U.S. Cl. CPC G08G 1/09626; G09B 5/02; H04L 67/306; B60R 2300/8086; B60K 2350/1004; G05D 1/0061

(57) ABSTRACT

A system for providing proactive service to a passenger of an autonomous vehicle during an autonomous-driving ride. The system includes a hardware-based processing unit, and a non-transitory computer-readable storage component including an input-interface module that, when executed by the hardware-based processing unit, obtains input data indicating a condition related to the autonomous-driving ride. The storage component also includes an actions module that, when executed by the hardware-based processing unit determines, based on the condition indicated by the input data, a proposed action; and proactively initiates dialogue with the passenger by way of a vehicle-passenger interface, the dialogue including proposing that the vehicle take the proposed action. Example actions include executing a conversation function, an educating function, an HVAC function, an autonomous-driving function, and an infotainment function. The technology in various embodiments includes any of the processes performed by the systems or devices described.

### TECHNICAL FIELD

The present disclosure relates generally to vehicle infotainment and, more particularly, to systems and processes for providing infotainment to vehicle occupants proactively and, in various embodiments to passengers of autonomous driving vehicles. The system may initiate one or more vehicle activities, such as modifying autonomous-driving functions, adjusting a vehicle route, or delivering in-vehicle entertainment, as a few examples.

### BACKGROUND

This section provides background information related to the present disclosure which is not necessarily prior art.

Manufacturers are increasingly producing vehicles having higher levels of driving automation. Features such as adaptive cruise control and lateral positioning have become popular and are precursors to greater adoption of fully autonomous-driving-capable vehicles.

While availability of autonomous-driving-capable vehicles is on the rise, users' familiarity and comfort with autonomous-driving functions will not necessarily keep pace. User comfort with the automation is an important aspect in overall technology adoption and user experience.

Also, with highly automated vehicles expected to be commonplace in the near future, a market for fully-autonomous taxi services and shared vehicles is developing. In addition to becoming familiar with the automated functionality, customers interested in these services will need to become accustomed to be driven by a driverless vehicle that is not theirs, and in some cases along with other passengers, whom they may not know.

Uneasiness with automated-driving functionality, and possibly also with the shared-vehicle experience, can lead to reduced use of the autonomous driving capabilities, such as by the user not engaging, or disengaging, autonomous-driving operation, or not commencing or continuing in a shared-vehicle ride. In some cases, the user continues to use the autonomous functions, whether in a shared vehicle, but with a relatively low level of satisfaction.

An uncomfortable user may also be less likely to order the shared vehicle experience in the first place, or to learn about and use more-advanced autonomous-driving capabilities, whether in a shared ride or otherwise.

Levels of adoption can also affect marketing and sales of autonomous-driving-capable vehicles. As users' trust in autonomous-driving systems and shared-automated vehicles increases, the users are more likely to purchase an autonomous-driving-capable vehicle, schedule an automated taxi, share an automated vehicle, model doing the same for others, or expressly recommend that others do the same.

### SUMMARY

The present technology solves many challenges, and provides many advantages for implantation of autonomous vehicles, and can be used with vehicles being manually driven as well.

In one aspect, the technology relates to a system, for providing proactive service to a passenger of an autonomous vehicle during an autonomous-driving ride. The system includes a hardware-based processing unit, and a non-transitory computer-readable storage component. The storage component includes an input-interface module that, when executed by the hardware-based processing unit, obtains input data indicating a condition related to the autonomous-driving ride.

The storage component also includes an actions module that, when executed by the hardware-based processing unit determines, based on the condition indicated by the input data, a proposed action; and proactively initiates dialogue with the passenger by way of a vehicle-passenger interface, the dialogue including proposing that the vehicle take the proposed action.

The proposed action may include adjusting a vehicle function selected from a group of functions consisting of: an autonomous-driving function, heating, ventilating, and air-conditioning (HVAC) function, and a vehicle-infotainment-system function.

In various embodiments, the storage component includes a database module storing a passenger profile comprising passenger-profile data; the input data includes the passenger-profile data; and the actions module, when executed by the hardware-based processing unit to determine the proposed action, determines the proposed action based on the passenger-profile data.

In various embodiments, embodiment, the storage component comprises a learning module that, when executed by the processing unit, determines learned data based on user activity; the learned data determined is stored in the passenger profile; and the actions module, when executed by the hardware-based processing unit to determine the proposed action, determines the proposed action based on the passenger-profile data including the learned data.

In various embodiments, the storage component includes a context module; the condition indicated by the input data includes context data regarding an in-cabin condition or an external condition; and the actions module, when executed by the hardware-based processing unit, determines the appropriate action based on the context data.

In various embodiments, the context data indicates one or more of an identity of the passenger; an age of the passenger; a cabin climate characteristic; and an outside-of-vehicle climate characteristic.

In various embodiments, the condition is an action-supporting condition; the input data comprises a trigger condition; and the actions module, when executed by the hardware-based processing unit, determines the proposed action in response to the trigger condition.

In various embodiments, the input-interface module, when executed, receives passenger approval of the action proposed; and the system comprises an output-group module that, when executed, initiates performance of the action proposed and approved.

In various embodiments, the action proposed and approved comprises an autonomous-vehicle driving function; and the output-group module comprises an autonomous-vehicle-driving module that, when executed, initiates performance of the autonomous-vehicle driving function.

In various embodiments, the action proposed and approved comprises a climate-control action; and the output-group module comprises a vehicle-controls module that, when executed, initiates performance of the climate-control action.

In various embodiments, the action proposed and approved comprises a conversation action; and the output-group module comprises a vehicle-passenger interface module, when executed, performs the conversation action by which the system converses audibly with the passenger by way of the vehicle-passenger interface.

In various embodiments, the conversation action is an educating action configured to inform the passenger about a non-vehicle-related, non-drive-related, topic of interest to the passenger; and the communications module, when executed, performs the educating action.

In various embodiments, the action proposed and approved comprises an external-communication action; and the output-group module comprises an external-communications module that, when executed, initiates performance of the external-communication action.

In various embodiments, the external-communication action comprises sending a notification to a third party device regarding status of the passenger or the autonomous-driving ride.

In various embodiments, the input data is received from a vehicle sensor having sensed the condition.

In various embodiments, the non-transitory computer-readable storage component comprises a user-model module that, when executed by the processing unit, provides user-model data indicating a preference or other quality of the user determined, wherein: the input data includes the user-model data; and the actions module, when executed by the hardware-based processing unit, determines the proposed action based on the user-model data and the condition.

In various embodiments, the non-transitory computer-readable storage component comprises a vehicle-apparatus-model module that, when executed by the processing unit, provides a vehicle-apparatus-model data indicating a quality of a vehicle apparatus, wherein: the input data includes the vehicle-apparatus-model data; and the actions module, when executed by the hardware-based processing unit, determines the proposed action based on the vehicle-apparatus-model and the condition.

In various implementations, the processing unit is used by, but not part of, the system.

The technology in various embodiments includes any of the processes performed by the systems or devices described above, and herein below.

For instance, the technology may include a process, implemented by system for providing proactive service to a passenger of an autonomous vehicle during an autonomous-driving ride. The process includes obtaining, by a hardware-based processing unit executing an input-interface module of the system, input data indicating a condition related to the autonomous-driving ride.

The process may also include determining, by the hardware-based processing unit executing an actions module of the system, a proposed action based on the condition indicated by the input data,

And the process may further include initiating proactively, by the hardware-based processing unit executing the actions module of the system, dialogue with the passenger by way of a vehicle-passenger interface, the dialogue including proposing that the vehicle take the proposed action.

In another aspect, the present technology relates to a system, for providing proactive services to a passenger of a vehicle, such as an autonomous vehicle during an autonomous-vehicle ride. The system includes a hardware-based processing unit and a non-transitory computer-readable storage component. The storage includes an input-interface module that, when executed by the hardware-based processing unit, obtains input data indicating one or more conditions related to an autonomous vehicle ride.

The storage also includes an actions module that, when executed by the hardware-based processing unit determines, based on the input data, an appropriate action under the conditions, and initiates, proactively dialogue with the passenger including proposing that the vehicle take the appropriate action.

The appropriate action may include an adjustment to one or more of: autonomous-driving functions, vehicle-heating, ventilating, and air-conditioning functions, and vehicle-infotainment-system functions.

In various embodiments, the storage component includes a database module storing a passenger profile, the input data includes the passenger profile data obtained from a database module, and the actions module, when executed by the hardware-based processing unit, determines the appropriate action based on the input data including the passenger profile data.

The storage component in some cases includes a learning module that, when executed by the processing unit, determines learned-conclusion data based on user behavior or other user activity, and the learning module or the actions module, when executed, updates to the passenger profile to include the learned-conclusion data.

The storage component includes a context module, in various implementations, the input data includes context data regarding an interior-vehicle context or extra-vehicle context, and the actions module, when executed by the hardware-based processing unit, determines the appropriate action based on the input data including the context data.

In some case, the context data indicates at least one of (i) an identity of the passenger, (ii) a route for the present autonomous-vehicle ride, (iii) an age of the passenger, (iv) a cabin climate condition, and (v) a climate condition outside of the vehicle.

The input data indicates a trigger condition in various embodiments, and the actions module, when executed by the hardware-based processing unit, determines the appropriate action based on the input data and in response to determining presence of the trigger condition.

In various embodiments, the storage component includes a user-interface module, the input-interface module, when executed, receives passenger approval of the action proposed, the action proposed includes the vehicle interacting with the passenger, and the user-interface module interacts with the user according to the action proposed.

The storage component includes a vehicle-functions-output module in some implementations, the input-interface module, when executed, receives passenger approval of the action proposed, the action proposed includes a vehicle function, and the vehicle-functions-output module, when executed, initiates the vehicle function.

In other aspects, the present technology relates to the non-transitory computer-readable storage component described above.

In still other aspects, the technology relates to an algorithm for performing the functions recited above, or processes including the functions performed by the structure mentioned.

Other aspects of the present technology will be in part apparent and in part pointed out hereinafter.

### DESCRIPTION OF THE DRAWINGS

FIG. 1 illustrates schematically an example vehicle of transportation, with portable and remote computing devices, according to embodiments of the present technology.

FIG. 2 illustrates schematically more details of the example vehicle computer of FIG. 1 in communication with the portable and remote computing devices.

FIG. 3 shows another view of the vehicle, emphasizing example memory components.

FIG. 4 shows interactions between the various components of FIG. 3, including with external systems.

FIG. 5 shows an example algorithmic diagram, from a perspective of the system, or intelligent agent.

FIG. 6 shows an example algorithmic diagram, from a perspective of a server of the present technology.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. TECHNOLOGY INTRODUCTION

The present disclosure describes, by various embodiments, systems and processes for providing infotainment proactively to vehicle occupants, and in various embodiments especially passengers of autonomous driving vehicles.

The infotainment comprises any of a wide variety of information, and system functions can include initiating vehicle activity, such as changing a planned route, adjusting HVAC or radio settings, starting a movie presentation via a vehicle screen, modifying autonomous-driving characteristics (speed, etc.), or initiating a dialogue with a passenger.

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, trains, trolleys, the like, and other.

While select examples of the present technology describe autonomous vehicles, the technology is not limited to use in autonomous vehicles (fully or partially autonomous), or to times in which an autonomous-capable vehicle is being driven autonomously. References herein to characteristics of a passenger, and communications provided for receipt by a passenger, for instance, should be considered to disclose analogous implementations regarding a vehicle driver during manual vehicle operation. During fully autonomous driving, the ‘driver’ is considered a passenger.

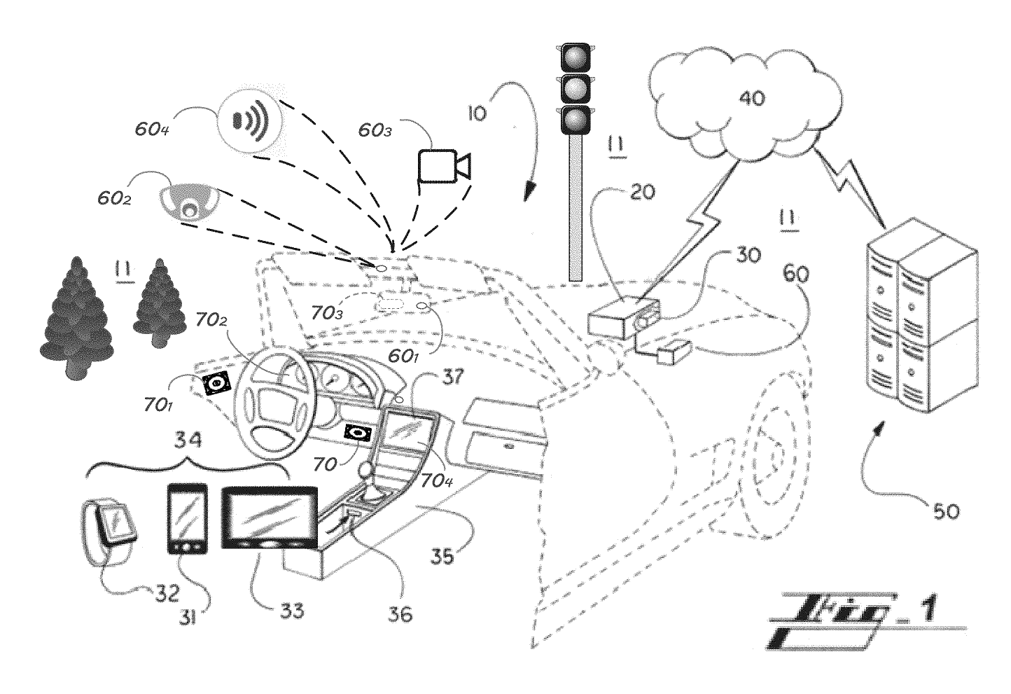

### II. HOST VEHICLE—FIG. 1

Turning now to the figures and more particularly the first figure, FIG. 1 shows an example host structure or apparatus 10 in the form of a vehicle.

The vehicle 10 includes a hardware-based controller or controller system 20. The hardware-based controller system 20 includes a communication sub-system 30 for communicating with portable or local computing devices 34 and/or external networks 40.

By the external networks 40, such as the Internet, a local-area, cellular, or satellite network, vehicle-to-vehicle, pedestrian-to-vehicle or other infrastructure communications, etc., the vehicle 10 can reach portable devices 34 or remote systems 50, such as remote servers.

Example local devices 34 include a user smartphone 31, a user-wearable device 32, such as the illustrated smart eye glasses, and a tablet 33, and are not limited to these examples. Other example wearables 32 include a smart watch, smart apparel, such as a shirt or belt, an accessory such as arm strap, or smart jewelry, such as earrings, necklaces, and lanyards.

Another example portable device 34 is a user plug-in device, such as a USB mass storage device, or such a device configured to communicate wirelessly.

Still another example portable device 34 is an on-board device (OBD) (not shown in detail), such as a wheel sensor, a brake sensor, an accelerometer, a rotor-wear sensor, throttle-position sensor, steering-angle sensor, revolutions-per-minute (RPM) indicator, brake-force sensors, other vehicle state or dynamics-related sensor for the vehicle, with which the vehicle is retrofitted with after manufacture. The OBD(s) can include or be a part of the sensor sub-system referenced below by numeral 60.

The vehicle controller system 20, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller 20 are in other embodiments executed via similar or other message-based protocol.

The vehicle 10 also has various mounting structures 35. The mounting structures 35 include a central console, a dashboard, and an instrument panel. The mounting structure 35 includes a plug-in port 36—a USB port, for instance—and a visual display 37, such as a touch-sensitive, input/output, human-machine interface (HMI).

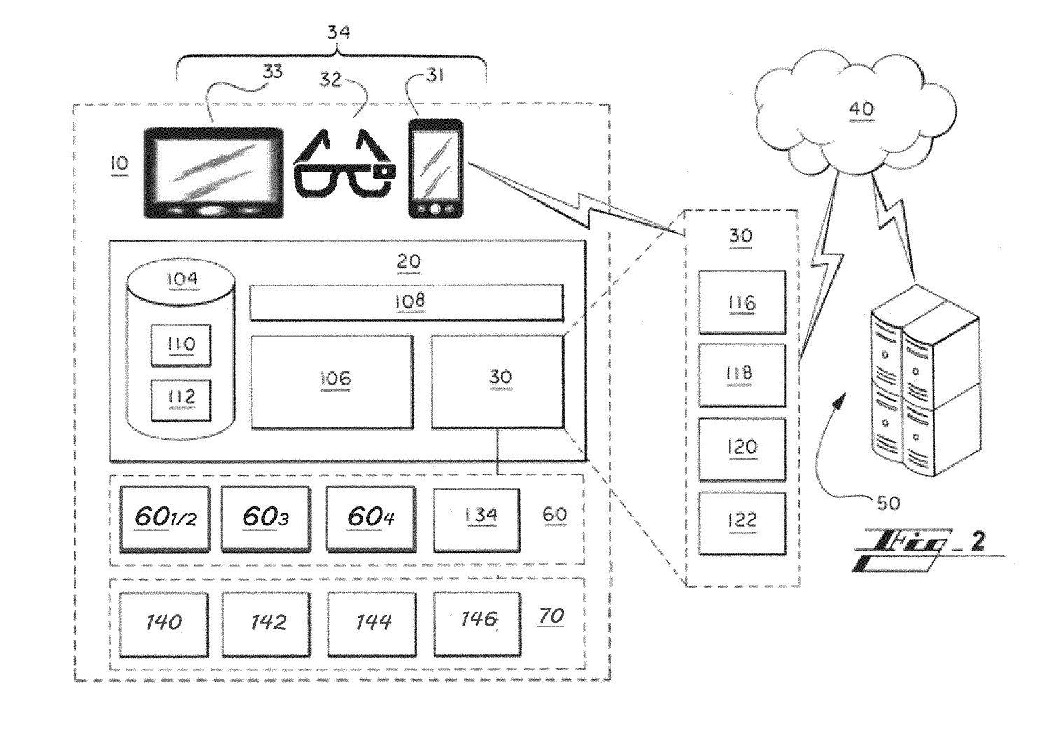

The vehicle 10 also has a sensor sub-system 60 including sensors providing information to the controller system 20. The sensor input to the controller 20 is shown schematically at the right, under the vehicle hood, of FIG. 2. Example sensors having base numeral 60 (601, 602, etc.) are also shown.

Sensor data relates to features such as vehicle operations, vehicle position, and vehicle pose, user characteristics, such as biometrics or physiological measures, and environmental-characteristics pertaining to a vehicle interior or outside of the vehicle 10.

Example sensors include a camera 601 positioned in a rear-view mirror of the vehicle 10, a dome or ceiling camera 602 positioned in a header of the vehicle 10, a world-facing camera 603 (facing away from vehicle 10), and a world-facing range sensor 604. Intra-vehicle-focused sensors 601, 602, such as cameras, and microphones, are configured to sense presence of people, activities or people, or other cabin activity or characteristics. The sensors can also be used for authentication purposes, in a registration or re-registration routine. This subset of sensors are described more below.

World-facing sensors 603, 604 sense characteristics about an environment 11 comprising, for instance, billboards, buildings, other vehicles, traffic signs, traffic lights, pedestrians, etc.

The OBDs mentioned can be considered as local devices, sensors of the sub-system 60, or both in various embodiments.

Portable devices 34 (e.g., user phone, user wearable, or user plug-in device) can be considered as sensors 60 as well, such as in embodiments in which the vehicle 10 uses data provided by the local device based on output of a local-device sensor(s). The vehicle system can use data from a user smartphone, for instance, indicating user-physiological data sensed by a biometric sensor of the phone.

The vehicle 10 also includes cabin output components 70, such as audio speakers 701, and an instruments panel or display 702. The output components may also include dash or center-stack display screen 703, a rear-view-mirror screen 704 (for displaying imaging from a vehicle aft/backup camera), and any vehicle visual display device 37.

### III. ON-BOARD COMPUTING ARCHITECTURE—FIG. 2

FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media.

The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

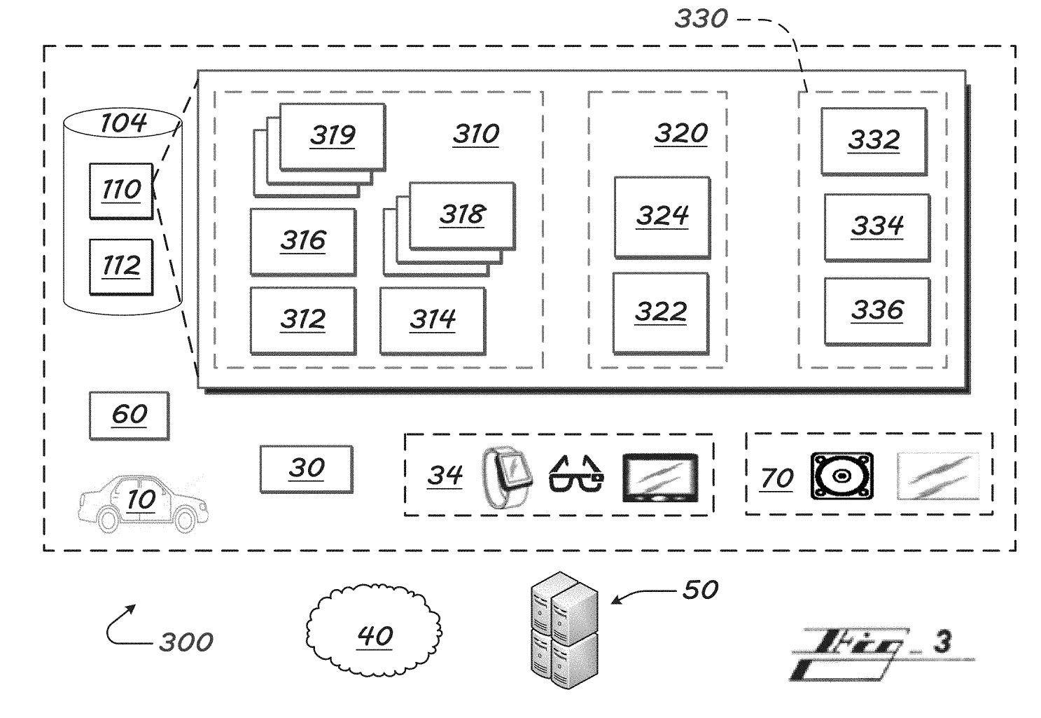

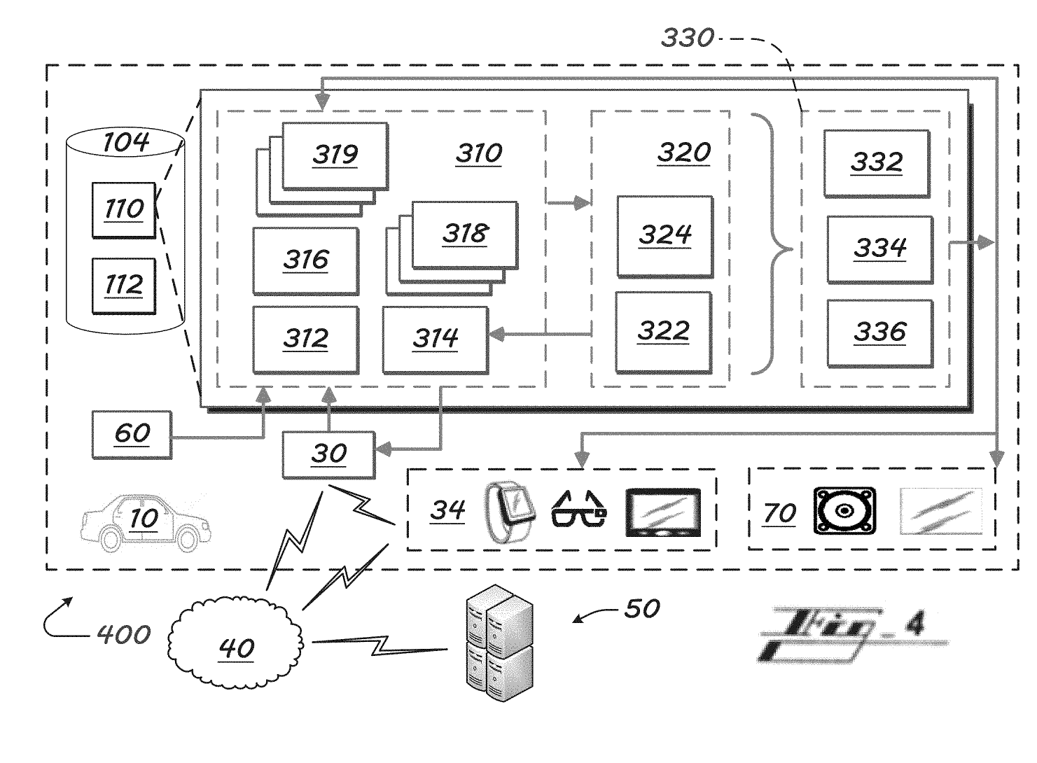

The data storage device 104 includes one or more storage or computing units or modules 110 storing computer-readable code or instructions executable by the processing unit 106 to perform the functions of the controller system 20 described herein. The modules and functions are described further below in connection with FIGS. 3 and 4.

The data storage device 104 in some embodiments also includes ancillary or supporting components 112, such as additional software and/or data supporting performance of the processes of the present disclosure, such as one or more user profiles or a group of default and/or user-set preferences.

As provided, the controller system 20 also includes a communication sub-system 30 for communicating with portable and external devices and networks 34, 40, 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in some embodiments configured to facilitate communications between the controller system 20 and a long-range network such as a satellite or cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as portable communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle computing device 20. A remote device 50 includes, for instance, a processing unit, a storage medium comprising modules, a communication bus, and an input/output communication structure. These features are considered shown for the remote device 50 by FIG. 1 and the cross-reference provided by this paragraph.

While portable devices 34 are shown within the vehicle 10 in FIGS. 1 and 2, any of them may be external to, and in communication with, the vehicle.

Example remote systems 50 include a remote server, such as an application server. Another example remote system 50 includes a remote control center, data, center or customer-service center.

The user computing or electronic device 34, such as a smartphone, can also be remote to the vehicle 10, and in communication with the sub-system 30, such as by way of the Internet or another communication network 40.

An example control center is the OnStar® control center, having facilities for interacting with vehicles and users, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controller system 20 regarding items such as vehicle operations, vehicle position, vehicle pose, user characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 604, such as radar or sonar, directed away from the vehicle, such as for supporting autonomous driving. In some embodiments a camera is used to sense range.

Visual-light cameras 603 directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 603 and the range sensor 604 may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 604 may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned cabin sensors (601, 602, etc.) configured and arranged (e.g., positioned and fitted in the vehicle) to sense activity, people, cabin environmental conditions, or other features relating to the interior of the vehicle. Example cabin sensors (601, 602, etc.) include microphones, in-vehicle visual-light cameras, seat-weight sensors, user salinity, retina or other user characteristics, biometrics, or physiological measures, and/or the environment about the vehicle 10.

The cabin sensors (601, 602, etc.), of the vehicle sensors 60, may include one or more temperature-sensitive cameras (e.g., visual-light-based (3D, RGB, RGB-D), infra-red or thermographic) or sensors. In various embodiments, cameras are positioned preferably at a high position in the vehicle 10. Example positions include on a rear-view mirror and in a ceiling compartment.

A higher positioning reduces interference from lateral obstacles, such as front-row seat backs blocking second- or third-row passengers, or blocking more of those passengers. A higher positioned camera (light-based (e.g., RGB, RGB-D, 3D, or thermal or infra-red) or other sensor will likely be able to sense temperature of more of each passenger's body—e.g., torso, legs, feet.

Two example locations for the camera(s) are indicated in FIG. 1 by reference numeral 601, 602, etc.—on at rear-view mirror and one at the vehicle header.

Other example sensor sub-systems 60 include dynamic vehicle sensors 134, such as an inertial-momentum unit (IMU), having one or more accelerometers, a wheel sensor, or a sensor associated with a steering system (for example, steering wheel) of the vehicle 10.

The sensors 60 can include any sensor for measuring a vehicle pose or other dynamics, such as position, speed, acceleration, or height—e.g., vehicle height sensor.

The sensors 60 can include any sensor for measuring an environment of the vehicle, including those mentioned above, and others such as a precipitation sensor for detecting whether and how much it is raining or snowing, a temperature sensor, and any other.

Sensors for sensing user characteristics include any biometric or physiological sensor, such as a camera used for retina or other eye-feature recognition, facial recognition, or fingerprint recognition, a thermal sensor, a microphone used for voice or other user recognition, other types of user-identifying camera-based systems, a weight sensor, breath-quality sensors (e.g., breathalyzer), a user-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and user-temperature, a sensor measuring salinity level, the like, or other.

User-vehicle interfaces, such as a touch-sensitive display 37, buttons, knobs, the like, or other can also be considered part of the sensor sub-system 60.

FIG. 2 also shows the cabin output components 70 mentioned above. The output components in various embodiments include a mechanism for communicating with vehicle occupants. The components include but are not limited to audio speakers 140, visual displays 142, such as the instruments panel, center-stack display screen, and rear-view-mirror screen, and haptic outputs 144, such as steering wheel or seat vibration actuators. The fourth element 146 in this section 70 is provided to emphasize that the vehicle can include any of a wide variety of other in output components, such as components providing an aroma or light into the cabin.

### IV. ADDITIONAL VEHICLE COMPONENTS—FIG. 3

FIG. 3 shows an alternative view of the vehicle 10 of FIGS. 1 and 2 emphasizing example memory components, and showing associated devices.

As mentioned, the data storage device 104 includes one or more modules 110 for performing the processes of the present disclosure. and the device 104 may include ancillary components 112, such as additional software and/or data supporting performance of the processes of the present disclosure. The ancillary components 112 can include, for example, additional software and/or data supporting performance of the processes of the present disclosure, such as one or more user profiles or a group of default and/or user-set preferences.

Any of the code or instructions described can be part of more than one module. And any functions described herein can be performed by execution of instructions in one or more modules, though the functions may be described primarily in connection with one module by way of primary example. Each of the modules can be referred to by any of a variety of names, such as by a term or phrase indicative of its function.

Sub-modules can cause the processing hardware-based unit 106 to perform specific operations or routines of module functions. Each sub-module can also be referred to by any of a variety of names, such as by a term or phrase indicative of its function.

Example modules 110 shown include:
Input Group 310
   input-interface module 312;
   database module 314;
   context module 316;
   user-model module 318; and
   vehicle-systems-model module 319, or vehicle-apparatus-model module, or vehicle-sub-system-model module;
Activity Group 320
   actions module 322; and
   learning module 324.
Output Group 330
   user-interface module 332;
   vehicle-functions module 334; and
   other-outputs module 336.

Other vehicle components shown in FIG. 3 include the vehicle communications sub-system 30 and the vehicle sensor sub-system 60. These sub-systems act at least in part as input sources to any of the modules 110, and particularly to the input interface module 312.

Example inputs from the communications sub-system 30 include identification signals from mobile devices, which can be used to identify or register a mobile device, and so the corresponding user, to the vehicle 10, or at least preliminarily register the device/user to be followed by a higher-level registration.

The communication sub-system 30 receives and provides to the input group 310 data from any of a wide variety of sources, including sources separate from the vehicle 10.

Example sources include portable devices 34, devices worn by pedestrians, other vehicle systems, local infrastructure (local beacons, cellular towers, etc.), satellite systems, and remote systems 34/50, providing any of a wide variety of information, such as user-identifying data, user-history data, user selections or user preferences contextual data (weather, road conditions, navigation, etc.), program or system updates—remote systems can include, for instance, applications servers corresponding to application(s) operating at the vehicle 10 and any relevant user devices 34, computers of a user or supervisor (parent, work supervisor), vehicle-operator servers, customer-control center system, such as systems of the OnStar® control center mentioned, or a vehicle-operator system, such as that of a taxi company operating a fleet of which the vehicle 10 belongs, or of an operator of a ride-sharing service.

Example inputs from the vehicle sensor sub-system 60 include and are not limited to:
bio-metric/physiological sensors providing bio-metric data regarding vehicle occupants, such as regarding occupant facial features, voice recognition, heartrate, salinity, skin or body temperature, etc.;
occupant-vehicle input devices, such as human-machine interfaces (HMIs) of the vehicle, such as a touch-sensitive screen, buttons, knobs, microphones, and the like;
cabin sensors providing data about characteristics within the vehicle, such as vehicle-interior temperature, in-seat weight sensors indicating occupant mass or weight, and intra-cabin motion-detection sensors; and
environment sensors providing data concerning conditions about a vehicle, such as from externally-focused vehicle cameras, distance sensors (e.g., LiDAR, radar), and temperature sensors.

The view also shows example vehicle outputs 70, and user devices 34 that may be positioned in the vehicle 10. Outputs 70 include and are not limited to:
audio-output component, such as vehicle speakers;
visual-output component, such as vehicle screens;
vehicle-dynamics actuators, such as those affecting autonomous driving (vehicle brake, throttle, steering);
vehicle-climate actuators, such as those controlling HVAC system temperature, humidity, zone outputs, adjustable window position, adjustable moonroof position, and fan speed(s); and
portable devices 34 and remote systems 50, to which the system may provide a wide variety of information, such as user-identifying data, user-biometric data, user-history data, contextual data (weather, road conditions, etc.), inquiries, instructions or data for use in providing notifications, alerts, or messages to the user or relevant entities such as authorities, first responders, parents, an operator or owner of a subject vehicle 10, or a customer-service center system, such as of the OnStar® control center.

The modules, sub-modules, and their functions are described more below.

### V. ALGORITHMS AND PROCESSES—FIG. 4

V.A. Introduction to the Algorithms

FIG. 4 shows an example algorithm, process, or routine represented schematically by a flow 400, according to embodiments of the present technology. The algorithms, processes, and routines are at times herein referred to collectively as processes or methods for simplicity.

Though a single flow 400 is shown for simplicity, any of the functions or operations can be performed in one or more or processes, routines, or sub-routines of one or more algorithms, by one or more devices or systems.

It should be understood that the steps, operations, or functions of the processes are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing unit 106, a processing unit of an user mobile, and/or the unit of a remote device, executing computer-executable instructions stored on a non-transitory computer-readable storage device of the respective device, such as the data storage device 104 of the vehicle system 20.

The process can end or any one or more operations of the process can be performed again.

V.B. System Components and Functions

FIG. 4 shows the components of FIG. 3 interacting according to various exemplary algorithms and process flows of the present technology.

Though connections between modules is not shown expressly, input group modules interact with each other in any of a wide variety of ways to accomplish the functions of the present technology.

As described, the input group 310 includes the input-interface module 312, the database module 314, the context module 316, the user-model module 318, and the vehicle-systems-model module 319.

The input-interface module 312, executed by a processor such as the hardware-based processing unit 106, receives any of a wide variety of input data or signals, including from the sources mentioned herein.

Output of any of the modules (input, context, learning 312, 316, 324, etc.) may be stored via the database module 314. And any of the modules 110 may use data stored at the database module 314.

Inputs to the input group 310, via the input-interface module 312, in various embodiments include data from any of a wide variety of input sources. Example sources include vehicle sensors 60 and portable or remote devices 34, 50, such as data storage components thereof, via the vehicle communication sub-system 30. Inputs also include a vehicle database, via the database module 314.

Sensor data or express-user input in various embodiments indicates a condition of the passenger. The vehicle sensors 60 can include physiological sensors for instance, such as a thermal camera, EEG, ECG, other such sensors mentioned above, or other sensors capable of sensing biometric or physiological characteristics of the passenger. The sensors 60 can also include other cameras configured and arranged (e.g., positioned and directed) to sense passenger presence, facial features, gestures, other passenger movements, and/or any such sensible passenger characteristic.

In a contemplated embodiment, sensor data can come from a non-vehicle apparatus, such as sensor data from a user portable device 34 carried by a passenger and sensing passenger characteristics—e.g., a mobile phone device camera.

Inputs to the input group 310, via the input-interface module 312, can also include passenger inputs to vehicle interfaces. Example vehicle interfaces include vehicle microphones, touch-sensitive screens, and cameras. The interfaces can also include vehicle apparatus control interfaces, such as controls (knobs, on-screen buttons, etc.) for a vehicle HVAC system, and controls for a vehicle infotainment system.

Inputs to the input group 310, via the context module 316, include information about the subject situation. The information can include cabin conditions, such as temperature, humidity, sound levels, the like, or other. Other example context information include information about an external environment of the vehicle, such as a temperature, humidity, our sound level outside of the vehicle 10. This information may be referred to as ambient information, about the ambient or surrounding environment for the vehicle. Other example context information includes number of passengers in the vehicle, the driving route, time of day, part of town, etc.

The user-model module 318 includes passenger or user models, or accesses such models, such as from a remote server 50. The system may include a user-model module for each of multiple users, such as automated taxi users, members of a family or company, etc.

In various embodiments, the models are user-specific, such that each model relates to a unique, corresponding user.

The user models can include or be a part of passenger profiles or accounts. The passenger profiles can include data representing passenger preferences or settings, established by the passenger and/or a system. Regarding system establishment, for instance, settings may be established or adjusted by a system, such as the vehicle system 20, based on observations of user activity or behavior over time, under one or more circumstances. The learning may be performed by the learning module 324, for instance. The user activity or behavior may include a pattern of activity or behavior noticed, such as a preferred radio station, or preferred station in late afternoon, after work on Friday's, or preferred hvac settings, driving settings, music genres, generally or under certain conditions, etc.

The user model for each passenger includes data structures representing the passenger. The structures can represent, or be used to learn or determine, passenger likes, preferences, or the like. Based on the user model, the system (e.g., actions module 322) can provide more accurate, custom service to the passenger, such as more accurate, customized information, vehicle control, entertainment, or dialogue between the vehicle and user.

The vehicle-systems-model module 319 includes system models, representing each of multiple vehicle systems. The module 319 may be referred to by other names, such as the vehicle-apparatus-model module, or vehicle-sub-system-model module.

The vehicle-apparatus model for each vehicle system includes data structures representing the vehicle system. Each vehicle-apparatus model can include data representing operation of a vehicle apparatus, such as vehicle-apparatus modes, states, or conditions.

Example models of the vehicle-apparatus model modules include an autonomous-driving model, of an A-D driving model module, an HVAC model, of an HVAC model module, etc.

The model can be affected by user input, such as in response to a passenger changing a system setting, such as by turning down an HVAC temperature. Based on the models, the system (e.g., actions module 322) can make more accurate decisions about how to adjust the vehicle systems—infotainment system(s), HVAC systems, autonomous-driving system, etc.

Any of the other inputs to the input group 310, or data generated at another input-group module, can be stored via the database module 314. The data can be stored to the vehicle data storage 104, and/or to local or remote systems, such as (1) a mobile device 34 storage, in communication with a mobile device app; (2) user computer, such as a tablet, laptop, or desktop computer having a storage, which may receive the data via an Internet connection and/or an application for the technology stored at the computer; or (3) a server or remote computer 50, such as a computer of a remote customer-service center like the OnStar® system.

The database module 314 can also receive data from other groups 320, 330, such as from the actions module 322 or the learning module 324 of the activity group.

Input-group data is passed on, after any formatting, conversion, or other processing (e.g., by the input interface module 312) to the activity group 320.

Any portion of the system may be referred to as an intelligent agent. The term stems from the technology being configured to make decisions and interact with the user in ways that conventional systems do not. A conventional HVAC system that increases a temperature setting by 5 degrees if a user presses an increase-temp-by-degree button 5 times is not intelligent. A system that determines by conversing with a vehicle passenger and/or on physiological or behavior (e.g., gestures) of the passenger, that the passenger would, or would likely, appreciate a lower temperature, or the windows rolled down a bit, is an intelligent agent.

The activity group 320 includes the actions module 322, and the learning module 324.

The activity module 322, when executed by a corresponding processing unit, determines one or more actions to take in response to the input data from the input group 310. The activity module 322 in various implementations requests (pull), receives without request (push), or otherwise obtains relevant data from the input group 310.

The activity module 322, in various embodiments, processes present, or present and past, stored, data to determine the one or more actions to take. The determining may include running programs or algorithms such as an artificial-intelligence decision-making algorithm. The activity module 322 or the learning module 324 may contribute to determining an action, by processing input data using a machine learning algorithm, or other suitable learning algorithm.

The activity module 322 determines, based on at least the input data from the input group 310, any of a wide variety of proactive actions to take or propose to one or more passengers.

The activity module 322 is configured in various embodiments to determine a communication to provide, or a proactive action to take, in response to determining that a triggering event or condition is present. In at least some of these embodiments, the triggering event or condition does not include a user request for action.

The activity module 322, instead, determines to initiate an action or a dialogue with a passenger, including proposing one or more potential actions and, based on the dialogue, determines whether the actions should be taken.

Example triggering events or conditions include any one or more of the following, and are not limited to:
i) an autonomous vehicle nearing a passenger's destination;
ii) the autonomous vehicle starting a long trip, warranting, e.g., a suggestion for some longer-duration type of entertainment, such as a move;
iii) a certain passenger being in the autonomous vehicle (e.g., a teenage child);
iv) a time context—e.g., a morning drive, warranting a proposal for some upbeat, cheerful music, or a late evening drive, warranting a proposal for relaxing music;
v) a cabin climate condition—e.g., cabin temperature being high or low;
vi) an external climate condition;
vii) a vehicle dynamic—e.g., a lower vehicle speed indicating that lowering the window is a good idea to cool the cabin without adding too much aerodynamic drag; and
viii) any condition indicated by or linked to passenger preferences, settings, or past activity or decisions—such as (A) an in-cabin temperature, being approached or arrived at, at which the system has noticed that the user has in the past tended to turn down the vehicle temperature setting (a corresponding action being, of course, to adjust the vehicle temperature accordingly, and perhaps communicate to the user that the same will be, is being, or was done), or (B) radio volume being at a certain level, under certain conditions, such as the music being at or below a certain level while driving after work with the windows down partially on the highway, wherein the user has tended historically under these circumstances to turn the volume up to a higher level (a corresponding action being, of course, to adjust the vehicle infotainment volume accordingly, and perhaps communicate to the user that the same will be, is being, or was done).

Example proactive actions proposed, including vehicle-to-user communications, and user-vehicle dialogues, include any one or more of the following, and are not limited to:
i. proposing to the user that an adjustment be made to a vehicle-climate system;
ii. proposing an adjustment to a non-HVAC vehicle system affecting effective passenger climate, such as window positions, sun/moon roof position, and seat temperature;
iii. proposing presentation of a movie or other infotainment;
iv. starting a dialogue, and possibly also determining if the passenger wishes to continue to dialogue—for instance, determining that, during a vehicle-user dialogue, the user seems engaged in the dialogue or otherwise interested in talking more;
v. proposing an adjustment to a vehicle dynamics system, such as an increase in automated-driving speed or a change of direction; and
vi. proposing a change in driving route, such as proposing that a more scenic route be taken.

Other exemplary use cases are provided below.

The learning module 324, based on any of a wide variety of inputs, determines ways to change a passenger profile. The system can determine, for instance, that the passenger reacts positively to proposals to re-routing, and so adjust a corresponding passenger profile to indicate that the passenger is not strict about maintaining a certain path, generally or under certain conditions such as when not in a hurry or under conditions such as when presented with proposed benefits of re-routing, such as expediency, increasing peace by taking a quieter or more-scenic route.

For performing such functions, the learning module 416 in various embodiments is configured to include artificial intelligence, computational intelligence, neural network or heuristic structures, or such suitable code.

Results of the activity group 320 are provided to various destinations. As mentioned, the destinations may include the database module 314 of the input module 310 and the learning module 324 of the activity group, via which subsequent activities of the system can be improved, such as by updating the passenger profile used in subsequent system activities.

A primary recipient of the activity group 320 in various embodiments is the output group 330. The modules of the output group 330 format, convert, or otherwise process output of the activity module 320 prior to delivering same to one or more of various output components.

The output group 330 includes the user-interface module 332, the vehicle-functions module 334, and the other-outputs module 336.

The user-interface module 332, when executed by the processing unit, initiates any system-passenger interactions determined appropriate by the activity group 320. The interactions can be effected via any HMI, whether of the vehicle 10. Example HMI includes those of the vehicle interfaces 70, such as a vehicle speaker and display screen, and interfaces of a portable, or user device 34, such as a mobile phone or tablet speaker or screen. Or a headset or earpiece connected to either the vehicle or portable device for providing audio to the user.

The vehicle-functions module 334, when executed by the processing unit, initiates any vehicle-function adjustments determined appropriate by the activity group 320. Example vehicle functions include:
i. vehicle dynamics, such as autonomous driving functions, like speed, turning, parking, and acceleration;
ii. functions of infotainment systems, such the radio or movie player;
iii. functions of vehicle systems affecting cabin climate, such as HVAC, windows, moon roof, seat heaters, etc.; and
iv. routing functions, such as changing a route in response to a vehicle proposed by and agreed to by the passenger via operation of the activity module 322.

The module 334 can include or be referred to by more specific terms, which may relate to specific module functions, such as the module being an autonomous-vehicle-driving module 334.

The other-outputs module 336, when executed by the processing unit, executes any other actions determined by the activity group 320. As an example, other outputs can include sending communications or messages to non-vehicle apparatus or addresses, such as local or remote systems, entities, or people (e.g., email address or phone of the user, parent, supervisor, authorities, etc.), such as to an operator of a fleet of autonomous vehicles of which a vehicle carrying the passenger is a part. The communication can include providing data to a remote server for updating a passenger profile, for use in record keeping and future use of the profile in connection with a later autonomous vehicle ride.

The other-outputs module 336 can include or be referred to by more specific terms, which may relate to specific module functions, such as the module being an external-communications module that in operation sends communications to third parties who are not on the ride, such as a parent, friend, supervisor, or fleet operator.

V.C. Additional Algorithm—Intelligent Agent Perspective

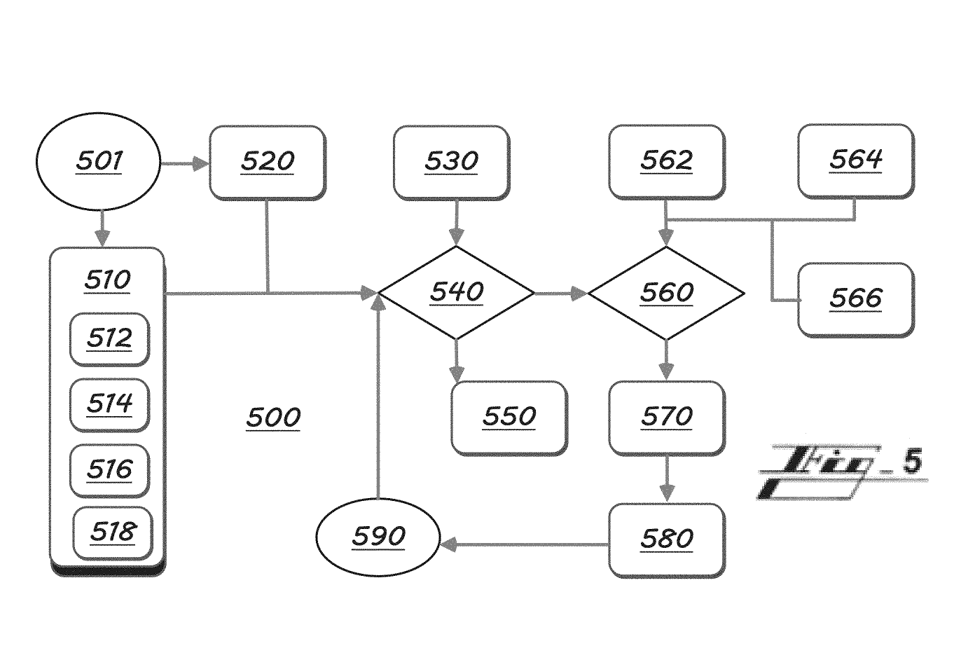

FIG. 5 shows an example algorithmic diagram 500, from a perspective of the system, or intelligent agent.

Though a single flow 500 is shown for simplicity, any of the functions or operations can be performed in one or more or processes, routines, or sub-routines of one or more algorithms, by one or more devices or systems.

It should be understood that the steps, operations, or functions of the processes are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing unit 106, a processing unit of an user mobile, and/or the unit of a remote device, executing computer-executable instructions stored on a non-transitory computer-readable storage device of the respective device, such as the data storage device 104 of the vehicle system 20.

The process can end or any one or more operations of the process can be performed again.

Each element shown may be or include a module, unit, model, function, code component, the like or other.

Though connections between each element is not shown expressly, the elements can interact with each other in any of a wide variety of ways to accomplish the functions of the present technology.

The algorithm 500 includes a user input unit 501, for receiving and passing on any input described expressly or inherently herein.

A sensor unit obtains input from any of a wide variety of sensors configured to measure user, cabin, or extra vehicle characteristics. Example sensors are described above, and here include a RGB camera 512, a thermal camera 514, a physiological sensor 516, or any suitable or desired sensor 518.

The algorithm also includes a speech unit 520, such as a speech recognition system, capable of converting audible user speech to data, such as text data, or other data indicating what the user speaks.

Another unit is an environmental context unit 530, such as one providing any of weather data, navigation data, traffic data, the like and other.

Input from any of the sensor, speech, and context units is provided to a user-state unit 540. The user-state unit in various embodiment includes any of the features described above in connection with the activity group 320 of FIGS. 3 and 4. The user-state unit determines a state (state x) for each user and/or circumstance, and determines an output action to take.

Output actions can be provided to an output sub-system, such as the output group 330 of FIGS. 3 and 4.

The output actions can include updating a server 550, such as the server 50 of FIGS. 1-4. The update may include updating a user profile, such as the updating of profiles described above.

The output actions may include determining one or more commands to be executed at the vehicle, such as to determine a communication to provide for receipt by the user by way of a vehicle-user interface 570, and providing such vehicle output 580.

Determining outputs may be based, in addition to the user-state output 540, on any of user-model data from a user-model unit 562, context-model data from a context-model unit 564, and vehicle-model data from a vehicle-model unit 566. The user and vehicle context units can be like the user-model module 318 and vehicle-systems-model module 319 described above in connection with FIGS. 3 and 4.

The context-model unit 564 represents present circumstances as a model, such as by providing as input to the decision 560 data representing any context related to the determination being made. The context may include, for instance, a user preference, preference of a group of passengers, a determined or stated mood of one or more passengers, infotainment media availability, HVAC setting option, etc.

In response to output from the vehicle output unit 580, such as an inquiry for the user, autonomous vehicle maneuver, etc., the user may provide further input, represented by user feedback unit 590. The system may here receive user input indicating a user response to the inquiry, a user statement, gesture, or other behavior indicating how they feel about the vehicle output—e.g., saying, ‘whoa!” if frightened by a, in their opinion, too-close passing maneuver. The user feedback from this unit 590 can be used to further update a user profile (reference server update unit 550) and/or as basis for the user-state determination of the mentioned user-state decision unit 540, as shown in FIG. 5.

The process of the algorithm can end or any one or more operations of the process can be performed again.

V.D. Additional Algorithm—Server Perspective

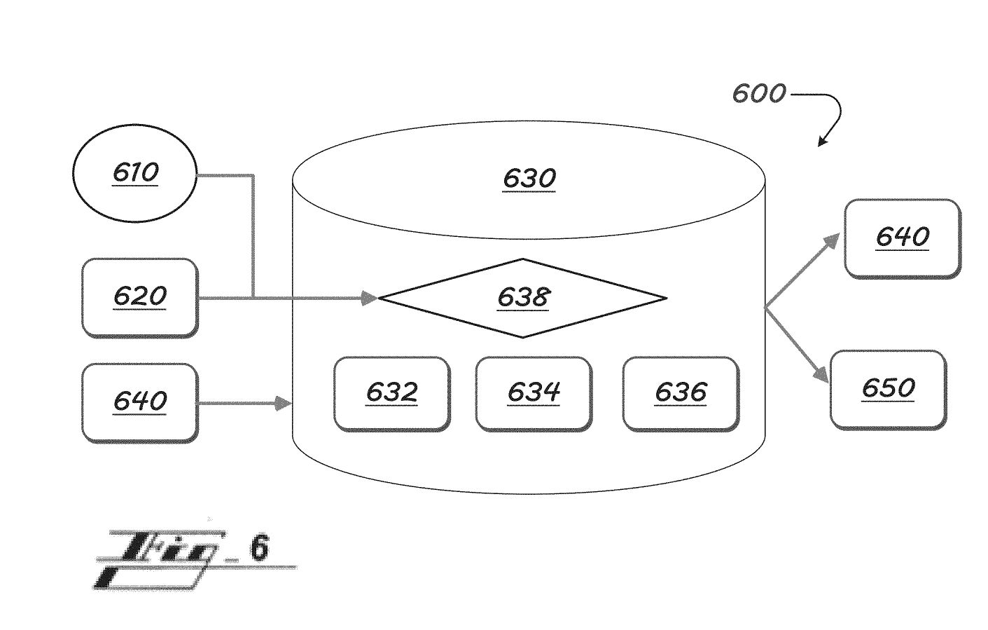

FIG. 6 shows an example algorithmic diagram 600, from a perspective of a server of the present technology.

Though a single flow 500 is shown for simplicity, any of the functions or operations can be performed in one or more or processes, routines, or sub-routines of one or more algorithms, by one or more devices or systems.

It should be understood that the steps, operations, or functions of the processes are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing unit of a specially configured server, configured with instructions for performing functions of the present technology, the functions performed upon the processing unit executing computer-executable instructions stored on a non-transitory computer-readable storage device of the respective device, such as the remote server 50 of FIGS. 1-4.

Each element shown may be or include a module, unit, model, function, code component, the like or other. The elements are referred to for simplicity primarily as units, below

Though connections between each element is not shown expressly, the elements can interact with each other in any of a wide variety of ways to accomplish the functions of the present technology.

The algorithm 600 also includes a user input unit 610, for receiving and passing on any input described expressly or inherently herein. The unit 610 in various embodiments includes any of the features described for the user input unit 501 of FIG. 5.

The user input may be processed, or proceed further or in a different way, at a user-input-processing unit 620 before being provided to a server 630. The server 630 can receive such processed input, or more raw input from the user-input 610.

The algorithm also includes an agent query unit 640, configured to provide to the server 630 a query for information from the vehicle system, such as from the intelligent agent of the vehicle. The vehicle system or agent requests the information, such as a user, vehicle, and/or context model information (reference 632, 634, 636) for use in any intelligent agent operations, including those described above in connection with FIG. 4.

The server 630 includes or is in communication with various units, such a user-model unit 632, a context-model unit 564, and vehicle-model unit 636. These units can in any way be like the user-model unit 562, the context-model unit 564, and the vehicle-model unit 566, respectively, describe above in connection with FIG. 5.

The server 630 at diamond 638 determines, based on at least inputs from the user 610, 620, and in some cases data from the agent query unit 640, a manner to update models. Example models updated as such include the mentioned models of the user-model unit 632, the context-model unit 564, and the vehicle-model unit 636.

In various embodiments, the models are used to perform system functions, whether at the server or at another system such as the vehicle system 20 or a portable device 34. Example functions include determining a user desire regarding a driving related operation, such as autonomous driving, HVAC functions, or infotainment, or determine a manner by which to interact with one or more passengers, such as what educational information the user is or may be interested in discussion under certain circumstances.

Model-update information generated can be sent from the server 630 to the vehicle system 20 via a vehicle-models update unit 640, to update versions of the same models in the vehicle software—e.g., the user-model unit 562, the context-model unit 564, and the vehicle-model unit 566 describe above in connection with FIG. 5.

Model-update information generated can also be sent from the server 630 to the vehicle system 20 via an agent-query-response unit 650, in response to the query received at the server 630 via the agent query unit 640.

The process of the algorithm can end or any one or more operations of the process can be performed again.

### VI. ADDITIONAL STRUCTURE, ALGORITHM FEATURES, AND OPERATIONS

In combination with any of the other embodiments described herein, or instead of any embodiments, the present technology can include any structure or perform any functions as follows.

The technology in various embodiments uses speech recognition to improve user experience, such as by determining content of a user request, or of a statement indicating a request or desire.

The technology in various embodiments enables a wide variety of uses, including providing proactive infotainment, vehicle-dynamics, and vehicle climate-related uses.

The system of the present technology in various embodiments is configured to proactively provide to a user information relevant to a trip and, in some embodiments, to propose to the user that another action be taken.

The technology in various embodiments is proactive in providing the passenger infotainment relevant to them.

The technology in various embodiments is proactive in keeping vehicle users engaged during driving, including a driver or passenger, including autonomous vehicle riders.

First example use case, regarding dialogue and trip-related information:
1. Vehicle: “Dave, we will arrive at your mother's house in 40 minutes; would you like a notification of your approach sent to her 15 minutes prior to arrival?”
2. Dave: “Sure, please.”—The system configured to interpret dialogue. Here, e.g., ‘sure, please’ determined by the vehicle system to be equivalent to ‘yes’, or in a more sophisticated embodiment, determined to be a ‘positive’ or ‘yes,’ but with some hesitancy, or less than a full-throated ‘yes.’

Second example use case, regarding dialogue and trip-related information:
1. Vehicle: “Laura, there are going to be construction areas along your usual route to work, today; do you mind changing to a longer route with less traffic? I assume it will be a more comfortable ride for you.”
2. Laura: “Oh, yes, please; I need to read and construction areas will bother me a lot.”

Third example use case, regarding dialogue and trip-related information:
1. Vehicle: “Laura, there are going to be construction areas along your usual route to work; do you mind if I change [or ‘do you mind changing’] to the longer road? It should be (or, ‘I assume it will be a more comfortable ride for you’).
2. Laura: “What are the estimated times of arrival?”
3. Vehicle: “The usual route, with construction, will take us about 25 minutes; the longer route, though having less construction, will take us 40 minutes”
4. Laura: “So stay the usual route; otherwise I will be late for my meeting”

Fourth example use case, regarding dialogue and weather:
1. Vehicle: “Alice, the weather seems to be very nice outside, would you like to have the window open; we can save some energy by reducing the air conditioner consumption . . . .”
2. Alice: “Sure.”

Fifth example use case, regarding dialogue and autonomous driving:
1. Vehicle (when arriving to destination): “Laura, there is a parking spot on your left.”
2. Vehicle: “Would you like to park there?”
3. Laura: “Yes.”
4. Vehicle executes the parking proposed autonomously.

Sixth example use case, regarding dialogue and proactive infotainment:
1. Kids traveling alone.
2. Vehicle: “Would you like me to read you a story, play a movie, or show you a new game?”
3. Jonny and Charlie: “a new game!”

Seventh example use case, regarding dialogue, and infotainment, in autonomous driving:
1. High schooler on the way to school.
2. Vehicle: “Any tests today?”
3. Lisa: “Yes, we have an exam in French, can we practice?”
4. Vehicle: “Sure . . . .”
5. Vehicle speaks with Lisa in French, at a level corresponding to her exam; or plays a lecture form an online course for same level. Lisa may communicate her level, or it may be stored in her user profile, for instance.

Eighth example use case, regarding dialogue, and infotainment, in autonomous driving:
1. High schooler on the way to school.
2. Vehicle: “Any tests today?”
3. Lisa: “Yes, exam in French.”
4. Vehicle: “Would you like to practice with me?”
5. Lisa: “Yes.”
6. Vehicle speaks with Lisa in French, at a level corresponding to her exam; or plays a lecture form an online course for same level. Lisa may communicate her level, or it may be stored in her user profile, for instance.

Ninth example use case, regarding dialogue and driver (as a driver or passenger) engagement:
1. Vehicle: “Dave, you have a 45 minutes of monotonous ride ahead, would you like to continue listening to Don Quixote?”
2. Dave: “Yes please”

Tenth example use case, regarding dialogue and infotainment:
1. Vehicle: “Laura, you look tired, would you like to listen to your road music track?”
2. Laura: “Yes please.”

Eleventh example use case, regarding dialogue, infotainment, and driver engagement:
1. Vehicle: “Dave are you enjoying the ride?”
2. David: “It's very monotonous.”
3. Vehicle: “How about some classic music?”
4. David: “OK, and tell me a joke please”
5. Vehicle: (starts music at low volume).
6. Vehicle: “Knock Knock . . . .”

Twelfth example use case, regarding dialogue and infotainment:
1. Vehicle: “Dave are you enjoying the ride?”
2. David: “It's very monotonous/boring.”
3. Vehicle: “How about I tell you some horoscopes (if, e.g., passenger profile indicates that the passenger likes horoscopes)?
4. David: Ok
5. Vehicle: delivers horoscopes by vehicle visual or audio (speaker) outputs 70.

### VII. SELECT ADVANTAGES

Many of the benefits and advantages of the present technology are described above. The present section restates some of those and references some others. The benefits described are not exhaustive of the benefits of the present technology.

In various embodiments the system promotes engagement between vehicle occupants and the vehicle. A driver enjoying autonomous driving for example, may be engaged more with the vehicle, which may be important in case the driver-passenger may need to take control of the driving, for instance.

The systems promote user comfort with and enjoyment of vehicle use including autonomous driving.

The technology in operation enhances driver and/or passenger satisfaction, including comfort, with using automated driving by adjusting any of a wide variety of vehicle and/or non-vehicle characteristics, such as vehicle driving-style parameters, HVAC, infotainment, etc.

The technology will lead to increased automated-driving systems functions. Users are more likely to use or learn about more-advanced autonomous-driving capabilities of the vehicle when they are more comfortable with the autonomous vehicle and autonomous-driving experience overall.

A ‘relationship’ between users and the vehicle is improved, The user will consider the vehicle as more of a trusted tool, assistant, and friend.

The technology can also affect levels of adoption and, related, affect marketing and sales of autonomous-driving-capable vehicles. As users' trust in autonomous-driving systems increases, they are more likely to purchase an autonomous-driving-capable vehicle, purchase another one, or recommend, or model use of, one to others.

Another benefit of system use is that users will not need to invest effort in setting or calibrating automated driver style parameters, as they are set or adjusted automatically by the system in connection with interactions with the user (learning functions, for example), to minimize user stress and therein increase user satisfaction and comfort with the autonomous-driving vehicle and functionality.

### VIII. CONCLUSION

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface may be referenced, for example, the referenced surface can, but need not be, vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for providing proactive service to a passenger of an autonomous vehicle during an autonomous-driving ride, comprising:
a hardware-based processing unit; and
a non-transitory computer-readable storage component comprising:
an input-interface module that, when executed by the hardware-based processing unit, obtains input data indicating a condition related to the autonomous-driving ride; and
an actions module that, when executed by the hardware-based processing unit:
determines, based on the condition indicated by the input data, a proposed action; and
proactively initiates dialogue with the passenger by way of a vehicle-passenger interface, the dialogue including proposing that the vehicle take the proposed action.

2. The system of claim 1 wherein the proposed action includes adjusting a vehicle function selected from a group of functions consisting of: an autonomous-driving function, heating, ventilating, and air-conditioning (HVAC) function, and a vehicle-infotainment-system function.

3. The system of claim 1 wherein:
the storage component includes a database module storing a passenger profile comprising passenger-profile data;
the input data includes the passenger-profile data; and
the actions module, when executed by the hardware-based processing unit to determine the proposed action, determines the proposed action based on the passenger-profile data.

4. The system of claim 3 wherein:
the storage component comprises a learning module that, when executed by the processing unit, determines learned data based on user activity;
the learned data determined is stored in the passenger profile; and
the actions module, when executed by the hardware-based processing unit to determine the proposed action, determines the proposed action based on the passenger-profile data including the learned data.

5. The system of claim 1 wherein:
the storage component includes a context module;
the condition indicated by the input data includes context data regarding an in-cabin condition or an external condition; and
the actions module, when executed by the hardware-based processing unit, determines the appropriate action based on the context data.

6. The system of claim 5 wherein the context data indicates one or more of
an identity of the passenger;
an age of the passenger;
a cabin climate characteristic; and
an outside-of-vehicle climate characteristic.

7. The system of claim 1 wherein:
the condition is an action-supporting condition;
the input data comprises a trigger condition; and
the actions module, when executed by the hardware-based processing unit, determines the proposed action in response to the trigger condition.

8. The system of claim 1 wherein:
the input-interface module, when executed, receives passenger approval of the action proposed; and
the system comprises an output-group module that, when executed, initiates performance of the action proposed and approved.

9. The system of claim 8 wherein:
the action proposed and approved comprises an autonomous-vehicle driving function; and
the output-group module comprises an autonomous-vehicle-driving module that, when executed, initiates performance of the autonomous-vehicle driving function.

10. The system of claim 8 wherein:
the action proposed and approved comprises a climate-control action; and
the output-group module comprises a vehicle-controls module that, when executed, initiates performance of the climate-control action.

11. The system of claim 8 wherein:
the action proposed and approved comprises a conversation action; and
the output-group module comprises a vehicle-passenger interface module, when executed, performs the conversation action by which the system converses audibly with the passenger by way of the vehicle-passenger interface.

12. The system of claim 11 wherein:
the conversation action is an educating action configured to inform the passenger about a non-vehicle-related, non-drive-related, topic of interest to the passenger;
the communications module, when executed, performs the educating action.

13. The system of claim 8 wherein:
the action proposed and approved comprises an external-communication action; and
the output-group module comprises an external-communications module that, when executed, initiates performance of the external-communication action.

14. The system of claim 13 wherein the external-communication action comprises sending a notification to a third party device regarding status of the passenger or the autonomous-driving ride.

15. The system of claim 1 wherein the input data is received from a vehicle sensor having sensed the condition.

16. The system of claim 1 the non-transitory computer-readable storage component comprises a user-model module that, when executed by the processing unit, provides user-model data indicating a preference or other quality of the user determined, wherein:
the input data includes the user-model data; and
the actions module, when executed by the hardware-based processing unit, determines the proposed action based on the user-model data and the condition.

17. The system of claim 1 wherein the non-transitory computer-readable storage component comprises a vehicle-apparatus-model module that, when executed by the processing unit, provides a vehicle-apparatus-model data indicating a quality of a vehicle apparatus, wherein:
the input data includes the vehicle-apparatus-model data; and
the actions module, when executed by the hardware-based processing unit, determines the proposed action based on the vehicle-apparatus-model and the condition.

18. A system, for providing proactive service to a passenger of an autonomous vehicle during an autonomous-driving ride, comprising a non-transitory computer-readable storage component comprising:
an input-interface module that, when executed by a hardware-based processing unit, obtains input data indicating a condition related to the autonomous-driving ride; and
an actions module that, when executed by the hardware-based processing unit:
determines, based on the condition indicated by the input data, a proposed action; and
proactively initiates dialogue with the passenger by way of a vehicle-passenger interface, the dialogue including proposing that the vehicle take the proposed action.

19. The system of claim 18 wherein:
the input-interface module, when executed, receives passenger approval of the action proposed; and
the system comprises an output-group module that, when executed, initiates performance of the action proposed and approved.

20. A process, implemented by system for providing proactive service to a passenger of an autonomous vehicle during an autonomous-driving ride, comprising:
obtaining, by a hardware-based processing unit executing an input-interface module of the system, input data indicating a condition related to the autonomous-driving ride;
determining, by the hardware-based processing unit executing an actions module of the system, a proposed action based on the condition indicated by the input data; and
initiating proactively, by the hardware-based processing unit executing the actions module of the system, dialogue with the passenger by way of a vehicle-passenger interface, the dialogue including proposing that the vehicle take the proposed action.
